(19) United States
(12) Patent Application Publication
(10) Pub. No.: US 2025/0022000 A1
(43) Pub. Date: Jan. 16, 2025

(54) INVENTORY MANAGEMENT SYSTEM FOR REDUCING FRAGRANCE WASTE

(71) Applicant: Life Spectacular, d/b/a Noteworthy Scents, San Francisco, CA (US)

(72) Inventors: Zaoshi Amy Yuan, San Francisco, CA (US); Ming S. Zhao, San Francisco, CA (US); Luke Weston, South San Francisco, CA (US)

(21) Appl. No.: 18/771,119

(22) Filed: Jul. 12, 2024

Related U.S. Application Data
(60) Provisional application No. 63/526,411, filed on Jul. 12, 2023.

(51) Int. Cl. G06Q 30/0202; G06Q 30/0204

(52) U.S. Cl. CPC G06Q 30/0202; G06Q 30/0204

(57) ABSTRACT

A system and method for reducing fragranced product industry waste by increasing accuracy of product recommendations for users, resulting in an decreasing a likelihood that fragranced products will be discarded prematurely. The system leverages a trained predictive model to determine true fragrance preferences and aversions. The predictive model is trained, at least in part, from user surveys intentionally de-emphasizing or entirely omitting industry vocabulary so as to elicit unbiased user responses.

### CROSS-REFERENCE TO RELATED APPLICATION(S)

This application is a nonprovisional patent application of and claims the benefit under 35 U.S.C. § 119 (e) of U.S. Provisional Patent Application No. 63/526,411, filed Jul. 12, 2023, and titled “Inventory Management System For Reducing Fragrance Waste,” the contents of which are incorporated herein by reference in its entirety.

### TECHNICAL FIELD

Embodiments described herein relate to computing systems, electronic devices, and system architectures configured to reduce chemical waste associated with creating, storing, and shipping fragranced products.

### BACKGROUND

Selecting fragranced products (e.g., cologne, parfum, candles, diffusers, and the like) for personal use is often an arbitrary and frustrating process for consumers. Retail consumers can be easily overwhelmed and fatigued trying to discriminate between subtly different fragrances while within a homogenous aromatic environment. Similarly, online recommendation tools typically only survey consumers for demographic information, resonance with brand identity, or scent note preferences. However, answers to these questions will often not reflect true consumer fragrance preferences, as many consumers are simply unfamiliar with industry vocabulary.

As a result, consumers often purchase fragranced products based on packaging, perceived exclusivity, and/or brand identity despite that the consumer may ultimately dislike the fragrances. Often. purchases are unused or discarded after a time, resulting in significant waste and supply chain inefficiency.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a system diagram of a system for determining accurate fragrance preferences of a fragranced product consumer, as described herein.

FIG. 2 depicts a host server and inventory management system that may operate as a component of, or with, the system of FIG. 1.

FIG. 3 depicts an example graphical user interface associated with a system for determining accurate fragrance preferences of a fragranced product consumer.

FIG. 4 depicts an example method of operating a system as described herein.

FIG. 5 depicts an example method for supplementing training data within a system as described herein.

FIG. 6 depicts an example method for supplementing training data within a system as described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to systems and methods for reducing waste associated with the purchase, storage, sale, and use of fragranced products. In particular, embodiments described herein reference systems, methods, and techniques for determining accurate, long term, aroma preferences of prospective consumers of fragranced products, thereby increasing the likelihood that a particular fragranced product will be used by its purchaser for its intended purpose over an extended period of time, and not discarded as waste in advance of purchasing a different fragranced product.

Further, a system as described herein can likewise influence inventory management operations and decisions for producers of fragranced products or, more generally, any organization within a fragranced product's supply chain.

For example, production, storage, shipping, and handling of precursor chemicals or additives used in the manufacturing of fragranced products can be controlled to only those quantities necessary to produce, store, and handle fragranced products that are actually used for their respective intended purposes, over their designed lifetimes, without a significant risk of being discarded as waste by a customer.

As may be appreciated by a person of skill in the art, a fragranced product (e.g., perfume, cologne, diffuser, essential oil, air freshener, personal care product additive, and so on) that does not match a consumer's preference, or triggers an aversion, often results in significant economic and environmental waste. Unlike other industries, such as food and drink services or consumer products industries, many fragranced products cannot be recycled, composted, or used for other purposes.

When a fragranced product is discarded, its container is likely to be broken, releasing the entirety of the fragranced product including solvents and volatile organic compounds (VOCs) into the local environment at once. The consumer is likely to purchase a different fragranced product to replace the unsuitable discarded product, thereby increasing overall demand for fragranced products. If the consumer again does not prefer, or has an aversion to, the second product, the cycle may repeat.

Across an entire industry, this cycle results in significant waste and unnecessary environmental pollution. For example, in a given year, a fragranced product may sell 10M units. In this example, only 70% of consumers may report a pleasant impression of that product after 30 days (note that returns are not typically accounted in annual unit sales), with that number dropping to 50% after 60 days. After 90 days, only 40% of purchasers may report an enduring pleasant impression, and continued use, of the fragranced product. In this example, upwards of 60% of the total units sold every year may be discarded, substantially unused. If each of the fragranced products were 50 ml, then 300,000 liters of product were wasted, evaporating into the local environment. This before any carbon emissions relating to the production, storage and shipping of those products is considered.

Exacerbating the wastage described above, a consumer with fading positive impressions of a fragranced product may be motivated to purchase additional fragranced products (e.g., to find a product the consumer likes) and potentially repeat this cycle multiple times per year, each time the discarded, unused product, releasing concentrated quantities of solvents and VOCs into the local environment.

By contrast to the foregoing example, a consumer in the 40% of persons reporting an enduring pleasant impression when using the fragranced product will be less likely to purchase other fragranced products, and will be more likely to use the original purchased product in a metered manner, resulting in release of the underlying compounds over period of days, months, or years and thus the overall pollutive effect of the consumer's use is significantly reduced.

More simply, the fragrance industry is simultaneously associated with both (1) high customer dissatisfaction and (2) with chemicals known to contribute to greenhouse gas effects and other environmental negatives. This combination results in an outsized carbon footprint for the fragrance industry on a per customer basis. Specifically, consumers of fragranced products often purchase a number of products in succession while trying to identify a fragrance that the consumer enjoys, over time accumulating significant quantity unused fragranced products. In other cases, fragranced products may be purchased as gifts for a recipient that may or may not enjoy the fragrance. In either case, unused, unliked, products are eventually discarded and the process of testing and accumulating soon-to-be unused or infrequently used fragranced products begins again. This cycle results in significant and unnecessary waste.

Embodiments described herein address these and other problems with fragrance industry waste by identifying a potential customer's true, long-term, aroma preferences, thereby significantly increasing a likelihood of several outcomes. First, the customer is less likely to prematurely discard a fragranced product prematurely. Second, the consumer is less likely to make accumulative fragranced product purchases. Finally, the consumer is highly likely to purchase the same product again, thereby decreasing the manufacturer's need to maintain inventory surpluses for a variety of different fragrances.

More simply, as the number of consumers leveraging a system as described herein (e.g., to accurately identify durable aroma preferences) increases, the manufacturers of those products—and more broadly any business within that supply chain—benefits from increased confidence in the precise quantities of raw materials, warehouse space, and so on necessary to fill repeat orders. In this manner, industry waste caused by overproduction and disposal can be significantly reduced.

In particular, systems described herein leverage cloud computing architectures and supervised machine learning to accurately identify long-lasting aroma preferences and aversions, without relying on customers possessing any preexisting knowledge of fragrance industry vocabulary. In addition, embodiments described herein relate to systems and methods for dynamically retraining one or more supervised machine learning models with user feedback and/or purchase data.

As noted above, conventional systems for assisting a consumer with selecting a fragranced product are typically focused to either (1) presenting a brand identity that may be appealing to a consumer or (2) are dependent upon the consumer possessing accurate knowledge of scent note vocabulary and terminology. As may be appreciated by many consumers and persons of skill in the art, these techniques are not useful for identifying fragrances that consumers actually prefer on a long-term basis, as conformity to a brand identity is entirely subjective and, additionally, most consumers do not have the knowledge or experience to understand descriptive terminology relating to the sense of smell.

For example, a consumer may not be aware of the difference between a chypre fragrance and a fougère fragrance. Similarly, a consumer may not be aware of differences between floral and sweet, or between leafy and herbal, or between mossy and woody.

In some cases, a consumer may believe incorrect information about a scent note, such as believing that a leathery scent is necessarily animal derived and non-vegan.

Further, many preexisting associations between brand identities (and/or common industry branding techniques) and particular scent notes may confuse or mislead consumers away from scents those customers may actually prefer or, in the alternative, may draw customers toward fragrances to which the consumer exhibits an aversion. For example, some consumers may avoid scents described as floral and some consumers may avoid scents described as leathery simply because those respective scent notes have historically been associated with gendered branding.

As a result, conventional survey-based methods of recommending scents to a consumer—whether online or in a retail environment—uniformly fail to identify a particular consumer's true preferences or aversions, thereby leading to waste as described above.

A system for identifying long-term aroma preferences and aversions as described herein can take the form of a server-client instance pair configured for recommending fragranced products to users. In particular, such a system can leverage a predictive model (e.g., a supervised trained model) to generate fragrance recommendations based on user input data. To generate the recommendation, the user may be asked to complete a survey of questions largely unrelated to scent notes or particular brand identities. In particular, the survey may be structured to as to gather broad personal attribute information about a person after which the user may be asked to sample and rank a set of fragrances.

For example, in many embodiments, a user may be asked a series of questions apparently unrelated to fragrance preferences. For example, questions may be asked about whether the user enjoys being outdoors, whether the user enjoys the ocean, whether the user has happy memories from childhood relating to food, and others. In many cases, questions may ask whether the user enjoys particular flavors or particular recognizable smells, without asking whether the user would purchase a fragranced product of that type. For example, the survey may ask whether the user associates happy memories or a positive impression with two-cycle engine exhaust, gasoline, or turpentine. Some questions may relate to whether the user enjoys the smell of cut grass or petrichor. The survey may likewise question whether the user enjoys the smell of a carbonated beverage, the smell of a chalkboard, sunscreens, and others. The survey may also ask questions related to well-known unique smells, such as peanut butter, yeast spread, wine, gasoline, acetone, markers or pens, chlorinated pools, formaldehyde, sulfur smell of an extinguished match, ozone, old books, mildew, dryer exhaust, hay, fish food, cooked rice, rubber tires, asphalt and tar, new plastic products, balloons, whiteboard/dry erase markers, WD-40 (or other similar household products or brands), leather, newspaper ink, talcum powder, rubbing alcohols, melted plastic, body odors, mothballs, cedar, and the like.

In addition, smells that may be nostalgic to a particular generation or demographic may be the subject of questions of the survey, such as the smell of a plastic VHS case, the smell of cigarette or pipe smoke, the smell of kerosene, the smell of shoe polish or wax, and so on.

A user may be asked any suitable number of questions; in many embodiments thirty or more questions may be asked. In addition to questions unrelated to fragrance preferences, aversions, or scent note vocabulary as described above, the survey may ask for demographic data such as gender, age, residence, and so on. In addition, the survey may include questions eliciting information related to personal preferences (e.g., foods, vacation types, favorite colors, and the like) and/or questions eliciting information relating to childhood memories.

The survey questions may be dynamic, and may vary from person to person whereas in other cases, the survey questions may be served to each person completing the survey. In some embodiments, the survey may also collect data on how often the user wears or uses fragrances, number of fragranced products generally used, time of day the user prefers to wear these fragrances, the strength of fragranced product preferred, and so on.

The survey may also ask about associations of colors and sounds with particular smells (e.g., associating green with the smell of grass, associating dropping water sounds with humid smells, and so on). In some examples, the survey can solicit information about the user's traditional aromatic note preferences, such as floral scents, spicy scents, woody scents, and so on. Similarly, the survey may collect data about the user's aromatic aversions to these smells and/or may infer aromatic aversions based on user selections.

As another non-limiting example, some survey questions may relate to food preferences. For example, a user may be prompted to select up to three taste preferences such as tuna, fresh fruit, herbs, and so on. In some embodiments, the survey asks questions related to everyday or household items, such as crayons, household chemicals, grass, trees, and so on. Some questions may be directed at items associated with distinct smells like menthol, fresh beer, old beer, baby powder, and potting soil. In some examples, the survey questions change depending on the user's answers to previous questions.

As noted above, a user may be asked to complete a survey such as described above and thereafter sample a number of fragrances, ranking each fragrance on a graduated scale.

The foregoing process is repeated with hundreds of different users, each answering questions generally unrelated to the fragranced product industry and each ranking a number of fragrances (e.g., 5 or more fragrances, 10 or more fragrances, and so on) blind to fragrance industry vocabulary that might be associated with those fragrances.

The foregoing data results in a training dataset that can be used for supervised training of a machine learning model. Specifically, the model—which may be a neural network, as one example—can be configured to receive, as input, a vector corresponding to survey results of a particular user and to provide as output, one or more labels corresponding to each sampled fragrance. As known by a person of skill in the art, depending upon an activation function chosen the machine learning model can be configured to provide a confidence as output (e.g., an activation) in respect of each fragrance sampled by the initial set of users completing the survey and sampling/ranking each respective fragrance.

Phrased in another non-limiting manner, a machine learning model can be trained to assign output labels corresponding to ranks of particular fragrances assigned by individual users in respect of a vector representation of survey results collected from that user. By training the system on a large collected dataset (i.e., the foregoing-described surveying operation across upwards of hundreds or thousands of individuals), it can be leveraged to assign predicted ranks of fragrances or fragranced products as labels to vectors representing input collected from a potential customer of fragranced products.

More simply, a first set of users' responses can be used to train a machine learning model to identify patterns and correlations between survey answers and individual fragrances. Thereafter, a second set of users can complete the same survey and the now-trained machine learning model can be used to predict with unprecedented fragrances truly preferred, long term, by each individual users in the second group.

To increase likelihood that the second group of users are provided with fragrances that do match long-term preferences, each user can be provided with a kit that includes a top N number of predicted fragrance matches. In one example, each user is provided with three samples. In addition, to improve statistical rigor, each user may be provided with M samples randomly selected from the available fragrance pool. Each of the samples provided to each user can be associated with an identifier. Thereafter, the user can make a selection and/or may rate one or more of the N+M fragrance samples. The user's selected fragrances can be thereafter be provided, with the user's survey results, as positive matching/labeling to the training data database (e.g., the data generated by the first set of users). Similarly, the user's rejected fragrances can be provided, alongside the user's survey results, as negative matching/labeling to the training data database.

As the user base of a system described herein grows, recommendations more accurately predict new users' true, long-term, fragrance preferences. These preferences, which may become purchase by a user, can be recorded as training data and the machine learning model can be retrained at regular intervals and/or manually.

More generally, survey responses and associated following actions (e.g., rating, purchases, returns, customer service interactions, and so on) can themselves be used as input data for a trained predictive model. In particular, the survey responses are received as input data by a server system. This data can be ingested by the predictive model or the machine learning model to provide a prediction for a fragranced product. More specifically, a machine learning model outputs a set of values that corresponds to a predicted user review (e.g., on a scale) for each fragranced product stored in the server system's database. In some embodiments, the fragranced product corresponds to a selection of fragranced product.

In some embodiments, an activation function output values for each of the fragranced products can be compared to a threshold to select a fragranced product or a set of fragranced product to recommend to a user. For example, the threshold value may indicate a likelihood that a user will be satisfied with the product, a high likelihood that the user will be very satisfied with the product, and so on. In some cases, output values can be ranked and the top fragranced products associated with the highest-ranked values are selected.

As used herein, the phrase “predictive model” refers to any hardware, software, or other circuit or processor or combination thereof configured to execute any suitable pattern recognition or classification algorithm, probabilistic model, artificial intelligence method, untrained or trained learning algorithms (e.g., supervised or unsupervised learning, reinforcement learning, feature learning, sparse dictionary learning, anomaly detection, or association rules, the like). These learning algorithms may utilize a single or any suitable combination of various models such as artificial neural networks, decision trees, support vector networks, Bayesian networks, genetic algorithms, or training models such as federated learning.

Once the host server provides output recommended fragrance or set of recommended fragrances, the user may elect to receive a sample set of the fragrances. For example, a host server may be communicatively coupled to a fulfillment service operable to receive the fragrance recommendation, query an inventory database, and generate a shipping manifest based on the dataset and the scent recommendation.

Once the user receives and samples the fragrances, the user may provide feedback on the sample set. For example, a user may provide a satisfaction score on the sample set as a whole. In some embodiments, the user provides a ranking of each fragrance from the sample set. As another example, the user assigns a score to each of the fragrances.

The received user feedback (e.g., score, ranking, and so on) may be used to retrain the predictive model, as noted above. For example, upon receiving user feedback, the host service may assign a neutral score, a low score, a negative score, or may keep the score output from the predictive model to the fragrance inventory that the user did not sample. The host server may then associate the sampled fragrance feedback and the unsampled fragrance value assignment to the user dataset. This data may then be used to retrain the predictive model. In some embodiments, the host server may select a subset of users to generate a retraining dataset and/or may filter outliers from the retraining dataset. The retraining sample may be based on a statistically significant number of users that have sampled the product.

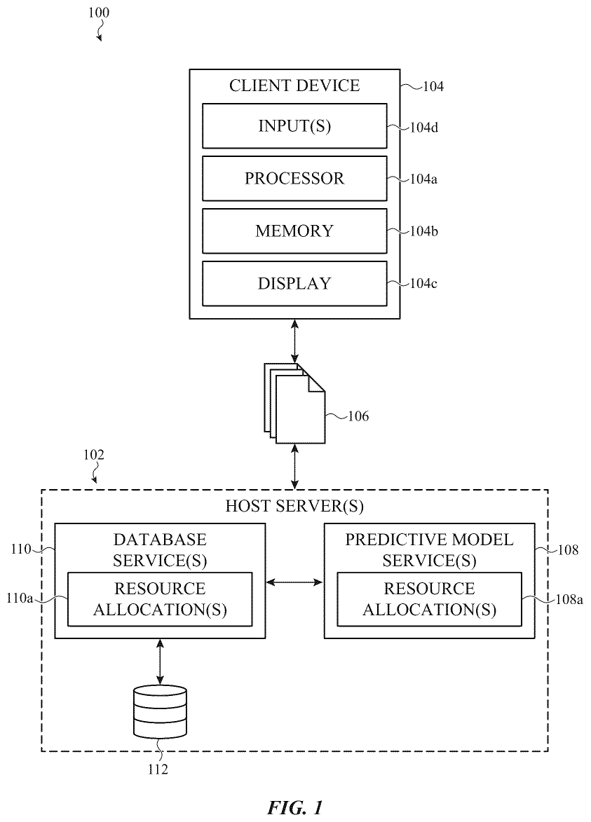

These foregoing and other embodiments are discussed below with reference to FIGS. 1-7. However, those skilled in the art will readily appreciate that the detailed description given herein with respect to these figures is for explanation only and should not be construed as limiting.

FIG. 1 is an example server system for generating a recommendation of a fragranced product based on received user input. The depicted server system is configured to receive user input from a frontend application. The frontend application includes a graphical user interface that displays a user survey. A user access and complete the survey using any suitable electronic device, such as a laptop, mobile device, table, smart watch, and so on.

In some embodiments, the user survey includes a set of visual cues to provide visual stimulation for the user, such as images that triggers a user's olfactory memory. The survey may allow the user to select a single answer, select multiple answers, not select any answers, and so on. This interface may be designed to avoid user frustration, particularly when the user does not identify with any of the answer choices or when a user cannot decide between multiple answer choices.

Once input data is received at the host server, a trained machine learning model may be instantiated or otherwise an existing instance can be accessed. The trained machine learning model can be trained using data stored in a database server, which can include data from a sample group, such as described above (e.g., survey data and values corresponding to that data representing a respective fragranced product).

In some embodiments, the trained machine learning model can be configured to provide, as output an operational result of activation function(s) of a set of neurons or nodes of a final layer of the trained model. The activation function(s) output can serve as a score corresponding to a positive recommendation (preference) or negative recommendation (aversion) in respect of each of a set of fragranced products.

These scores, which can range from 0 to 1.0 in some embodiments, can correspond to a predicted likelihood that a user or consumer will be satisfied or very satisfied with a fragranced product or with a likelihood that the fragrance will elicit a positive impression in the user. Based on the score, the server system can select a subset of fragranced products with scores satisfying a threshold or, alternatively, selects a subset of fragranced products according to a ranking. The recommendations may be displayed to a user at the frontend application. In some cases, the application displays a purchase or check out prompt to provide samples of the selected subset of fragrances. In some cases, the selected fragranced products are not displayed to the user to avoid bias during the sampling process.

As illustrated in FIG. 1, the system 100 includes a host server 102 (or computing system) that communicates with client devices, such as client device 104, or other servers which receive and transmit data from and/or to the client devices and to and/or from the host server. For example, the client device 104 transmits user data as data items 106 (e.g., user aromatic preferences, user aromatic aversions, user location data, user demographic data, user purchase data, and so on). The host server 102 receives those data items 106 and transmits, as data items 106, data regarding fragranced product recommendation.

The client device 104 can be any electronic device and can include a processor 104a, volatile or non-volatile memory 104b, a display 104c, and an input sensor or an input device 104d. These components can cooperate to perform or coordinate one or more operations of the client device 104 as it transacts information (e.g., via packets 106) with the host server 102.

The processor of the client device 104 can be configured to execute and/or instantiate an instance of an application (herein referred to as a “client application”) stored at least in part in a memory. In particular, the client device 104 can be configured to leverage a processor to access the memory to retrieve at least one executable asset (e.g., source code, binary files, and so on). By interoperation with the memory, the processor may instantiate an instance of the client application. The client application can be a browser application, a native application, or a combination thereof, which can be accessed via a private or public network (e.g., the internet). The frontend application can be configured to communicably intercouple to a backend instance of software hosted by the host server 102.

In some embodiments, the host server 102 leverages one or more processor allocations or processing resources—all configurations of which necessarily implicate physical hardware—to load, from a non-transitory memory allocation or resource, an executable asset(s). The processor allocation can cooperate with the memory allocation to instantiate an instance of backend software configured to provide an interface with which corresponding frontend instance of software can communicate. For simplicity of description and illustration, these example hardware resources are not shown in FIG. 1.

The host server 102 includes services or other virtual machines that perform one or more functions or operations. For example, the host server 102 includes predictive model services 108 and database services 110. Each of the predictive model service 106 and the database service 108 are associated with allocations of physical or virtual resources (identified in the figure as the resource allocations 108a and 110a respectively), such as one or more processors, memory, and/or communication modules (e.g., network connections and the like), though such an implementation is not required. The functions host server 102 can be performed by any suitable physical hardware, virtual machine, containerized machine, or any combination thereof.

As depicted in the figure, each the predictive model service 108 and the database service 110 are communicably coupled to each other and to one or more services (not shown) of the host server 102. In some embodiments, these one or more functions or operations include receiving user data, generating recommendations based on the user data, receiving client purchase information, coordinating with a fulfillment service to send fragranced products, and so on.

The predictive model service 108 accesses one more predictive models via the database service 110. As described herein, the predictive model(s) are initially trained using survey data and values corresponding to user satisfaction with a range of fragranced products obtained from a sample group (e.g., a group of more than 100 individuals which completed the survey, sampled the fragranced products, and provided feedback). The predictive model may be stored in any suitable form accessible to the predictive model service 108, such as the databases 112 accessed via the database service 110.

The database service 110 of the host server 102 can be configured to host and/or otherwise service requests to access to one or more databases or data sources, internal or external to the host server 102. Example databases are illustrated as the databases 112 and can include a sample group database, a user feedback database, a user service database, fragranced product database, a third party database, and so on.

These foregoing embodiments depicted in FIG. 1 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

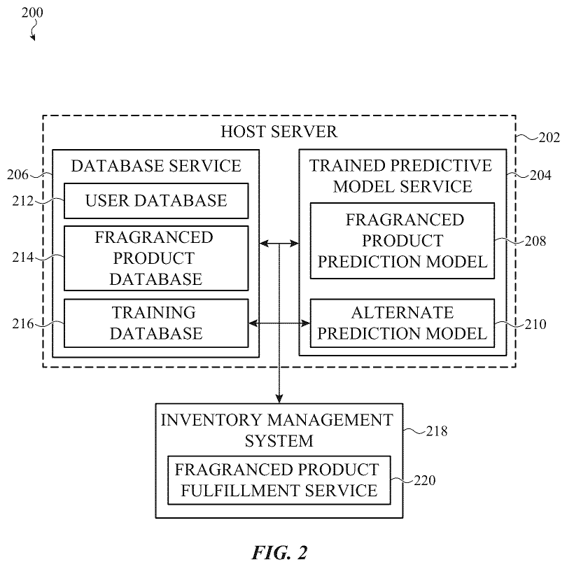

FIG. 2 is an example system diagram of a recommendation service 200. In some embodiments, the recommendation service 200 provides a fragrance recommendation to a user and communicates with an inventory management service that receives the fragrance recommendation and informs inventory management operations in response (e.g., automatically print shipping labels, automatic fragrance selection from inventory, automatic SKU reordering, and so on). In particular, the recommendation service 200 includes a host server 202 which instantiates a number of services, including a predictive model service 204 and a database service 206.

The predictive model service 204 may include a fragranced product preference prediction model 208 and a auxiliary prediction model 210 (which may be optional in some embodiments). The fragranced product preference prediction model 208 is a trained prediction model, such as described above. The model is trained to select/label at least one fragrance that will likely or highly likely satisfy a user's fragrance preferences for an extended period of time.

For example, in some cases the fragranced product preference prediction model 208 can be configured to select a particular fragrance mixed by a scent designer. The fragrance may be a SKU available for purchase or may be an additive that may be packaged at different concentrations in different products.

In other cases, the fragranced product preference prediction model 208 can be configured to associate particular constituent ingredients that, in turn, may be used by a scent designer to create a custom fragrance. In these examples, the underlying survey data may be generated by requesting survey-takers to rate individual single scents on different scales, in lieu of rating pre-mixed fragrances including multiple distinct tones. More simply, in some embodiments, initial training data may be generated on a per-aroma basis or a per-fragrance basis (i.e., an expertly mixed/combined set of multiple discrete smells/aromas).

In either case, a person of skill in the art may appreciate that the operation of the fragranced product preference prediction model 208 can serve to identify individual fragrances or aromas that may evoke a pleasant reaction in a particular user.

In still further examples, the initial dataset may be created by requesting survey-takers to sample a wide variety of individual specific aromas at different concentrations of each. The order in which these samples are provided to a survey taker is randomized. In such examples, a particular user may rate a particular aroma pleasant at low concentration and unpleasant at high concentration. In either case, the user may be blind to the aroma's name, source, or other identifying information.

In these examples, the fragranced product preference prediction model 208 can be trained to output activations associated with individual constituent scent components, given a vector representing answers to survey questions. In these cases, truly custom fragrances can be mixed (and/or information can be provided to a scent designer in respect of a particular user) based on the user's preferences and based on industry knowledge of pleasant scent pairings or combinations.

Further, by illuminating a particular user's preferences or aversions to particular aromas and particular combinations of aromas, more accurate selection of designed fragrances can be achieved. For example, if a particular user strongly prefers lemon oil aroma and cedar aroma but has a strong aversion to cut grass and spices, common designed fragrances that pair herbal notes with lemon oil or leathery notes with spices may not be preferred by the user, despite a strong preference for overtones of those designed fragrances. In these examples, custom combinations of ingredients-optionally informed by input from a scent designer-may be prepared for a user so as to avoid the user's appreciated or unappreciated aversions while promoting a user's appreciated or unappreciated preferences.

In yet other examples, the fragranced product preference prediction model 208 can be configured to determine different aroma/fragrance preferences exhibited by a user in different contexts. For example, the user may prefer ambient fragrances to be different from body fragrances to be different still from candle fragrances. In different contexts, a single user may prefer different concentrations, different over tones, under tones, different solvents or additives and so on.

These foregoing embodiments, as may be appreciated by a person of skill in the art, serve to pair a particular fragrance, designed or custom, to a particular user without the user being required to select or self-report preferences. However, a user's inherent marketing and identity-based biases also often influence whether a positive experience will be evoked or not.

For example, some users-whether intentionally or subconsciously-will not purchase or sample a product marketed as a perfume exclusively to women, despite that the underlying scents, fragrances, and aromas would be enjoyable to that user. Similarly, some users, whether intentionally or subconsciously, will not purchase a product marketed as a cologne exclusively to single young men.

More simply, a particular designed fragrance can be marketed to a first demographic and may be popular within that demographic. Marketing the same designed fragrance in the same manner to a different demographic may result is effectively no sales. However, marketing the same designed fragrance in a different manner that targets the second demographic may result in significant sales.

In short, despite that users in a blind sampling environment may prefer a particular aroma or designed fragrance, branding and brand identity associated with commercially available products incorporating that fragrance have significantly outsized influence over a particular user.

To account for these and other conscious or unconscious bias of a user that can lead to suboptimal fragrance purchases and result in waste, embodiments described here can include a auxiliary prediction model 210.

The auxiliary prediction model 210 may be configured for a number of complementary operations, such as determining likelihood of co-occurrence of multiple fragrance preference given a particular training dataset, determining a user's likelihood of exhibiting bias with respect to particular branding of a selected fragrance, and so on.

For example the auxiliary prediction model 210 can be configured to receive as input subsets of demographic questions and identity questions asked of a user in a survey that can correlate with a user's various internal biases towards or against particular brand identities or branding techniques. For example, traditionally “masculine” vocabulary can be used to describe a fragrance for some users, whereas traditionally “feminine” synonyms can be used to describe a fragrance for other users-despite that both users receive, and are likely to enjoy, the same fragrance.

For example, the auxiliary prediction model 210 can be used to predict a user's likelihood of having strong resonance with stereotypically masculine vocabulary. In response to a strong indication (e.g., high neuron activation) predicted by the auxiliary prediction model 210, different branding may be applied to fragrances recommended by the fragranced product preference prediction model 208 when providing the recommendation to the user. For example, in place of abstract descriptors such as a “floral bouquet,” descriptors such as “hearty wildflowers” may be used.

Oppositely, if operation of the auxiliary prediction model 210 predicts a strong indication of a user resonating with stereotypically feminine vocabulary, abstract descriptors such as “earthy and herbal” can be replaced with “an undisturbed field” or similar. A person of skill in the art may appreciate that the auxiliary prediction model 210 can be operated in a number of suitable ways to determine whether the same fragrance can be presented and/or described in a manner that increases a likelihood of eliciting a positive experience with a particular user.

More generally, the fragranced product preference prediction model 208 can be used to identify a particular fragrance or set of fragrances a user is likely to enjoy on a long-term basis. The auxiliary prediction model 210 can be used to identify a manner in which that fragrance is presented or described to that user so as to decrease a likelihood that the user's biases toward or against particular brand imagery or scent note vocabulary will influence the user's experience of sampling the selected fragrance(s).

For example, in some examples as noted above, a user may adopt the false impression that the user does not enjoy scents described as “floral.” In many cases, a user's belief may bias the user away from sampling or purchasing fragranced products described as floral, regardless of the actual scent and its overtones, undertones, or dry down characteristics. In these examples, the auxiliary prediction model 210 can be used to adjust descriptive terminology so as to avoid the user's bias-the term “floral” and similar phrasing may not be used in describing one or more fragrances recommended by the fragranced product preference prediction model 208.

In yet other examples, the auxiliary prediction model 210 can be used to select or inform packaging colorways or other schemas for a particular user. For example, a user that resonates with stereotypically masculine vocabulary and imagery may be more likely to sample a fragranced product packaged in a dark-color container with sharply defined edges, having red or orange accents. Similarly, a user that resonates with stereotypically feminine vocabulary and imagery may be more likely to sample a fragranced product in a light-colored container, with soft, rounded edges with pastel accents and cursive marketing copy. A person of skill in the art may readily appreciate that nongendered or neutral branding and packaging may be selected for other users.

More simply, in view of the foregoing examples which are not exhaustive, a system as described herein can be configured to identify a fragrance a user is likely to enjoy and a manner of presenting, describing, and packaging that fragrance to the user in a manner that avoids negative effects of the user's inherent biases illuminated, at least in part, by the user's responses to survey questions.

As a trivial example, output of the auxiliary prediction model 210 may determine whether a particular fragranced product is identified as a perfume, a cologne, or a general fragrance. As another example, output of the auxiliary prediction model 210 can be used to determine whether a particular fragranced product is marketed with a blue colorway or a pink colorway.

In other examples, the fragranced product preference prediction model 208 can operate without the auxiliary prediction model 210; the auxiliary prediction model 210 may be optional in some embodiments and/or the fragranced product preference prediction model 208 can be configured and/or trained to perform operations of the auxiliary prediction model 210 as described above.

More generally, once one or more predictive models are trained, the predictive service 204 can leverage these models to predict whether a user will prefer a particular fragranced product or whether a user will prefer certain fragrance preference and aversion profiles (undertones, overtones, dry down, and so on) associated with various fragranced products. More simply, the fragranced product preference prediction model 208 can predict a fragrance preference, but as known to a person of skill in the art, fragrances may be expressed in different ways when used to enhance a particular product.

For example, a first fragranced profile may be associated with different combinations, mixtures, concentrations, and pairings for body-worn fragrances, candles or other home fragrances, laundry detergent, cleaning products, car fragrances, and so on. While these products may present differently in accordance with use of the product (e.g., a laundry detergent might have a mild aroma compared to a body-worn fragrance), the base notes and/or fragrance theme may be similar such that a user finds each designed fragrance in each fragranced product pleasing.

The database service 206 can communicably couple the predictive model service 204 to one or more databases, including a user database 212, a fragrance database 214, a training database 216, and so on. For example, the user database 212 stores user data and/or demographic data including the user's preferences, the user's aversions, the user's food preferences, the user's olfactory memory triggers, the user's age, general city and/or general location data, childhood background information, and so on.

The user database 212 includes appropriate security protocols to protect user data. In some examples, identifying information, such as the user's name and purchasing information may be hashed (salted or otherwise), removed, or otherwise de-identified in the database to avoid bias in the training model and/or otherwise protect the user's identity. The user data may be self-reported or may be optionally obtained, with consent if required, from other sources.

The fragrance database 214 can be configured in any suitable manner to store information related to the fragranced products available in a brand's product suite. For example, the fragrance database 214 may store a set of fragrance ingredients, constituents, or additives that may be recommended to a user based on the received responses from the user survey.

The training database 216 can be configured to store information related to the sample group used in the initial dataset (e.g., the training data used from the auxiliary prediction model 210). For example, the training database 216 may include sample group survey data and/or a set of values associated with each data item of the user survey linked with a set of values from the sample fragrances associated with the sample group's response for each of those fragrances.

As the host server receives user data (e.g., not from the sample group) and fragrance preference feedback (e.g., from the at least one recommended fragranced product samples), the training database may update its data to include those data items. As the updated dataset becomes larger, the predictive model (e.g. the fragranced product preference prediction model 208) may be retrained using this data.

In some embodiments, the database services 206 can include other databases, such as databases that can be configured in any suitable manner to store third-party information (e.g., other fragrance brands and/or formulations), user feedback (e.g., provided to the host server via the frontend application, obtained via third-party reviews, and so on), the statistical likelihood that a user will be satisfied with a fragrance or constituent thereof, or any other suitable data, including the highest-ranked (popular) fragranced products for users that do not wish to take the survey and/or neutrally-ranked (inoffensive) fragrances for general commercial settings, such as an office.

In some embodiments, the system 200 includes an inventory management system 218. The inventory management system 218 may be a service configured to communicably couple to API endpoints associated with various supply chain management operations. In some examples, the inventory management system 218 is communicably coupled to the host server 202.

In one example, when the host server 202 receives a user order including a selection of at least one fragranced product, the host server 202 may query an API endpoint of the inventory management system 218 to verify that the fragranced product is available. If the fragranced product is available, a recommendation can be provided to a user (e.g., by displaying specific fragrance recommendations, by notifying the user that a sample kit of undisclosed fragrances has been selected, and so on). If the fragranced product is not available, the host server 202 may update the recommendation to a different fragranced product that meets a threshold quantity selection criteria.

When a recommendation is provided, the user may be prompted for purchase information to buy the recommended fragranced products (e.g., samples, sample kit, full-size, and so on). Upon receiving purchase information, the host server 202 provides the inventory management system 218 and/or a fragrance fulfillment service 220 data to fulfill the user's order, which may include as noted, can include multiple fragrance samples including random samples not selected by the user at all (for reinforcement retraining of one or more predictive model). The user's survey data and identifiers associated to the fragrances shipped to the user may be stored by the database service 206.

In this manner, if the user makes purchases subsequent to receiving the various fragrances sent to the user, training data can be added to the training database 216. For example, if the user orders a larger quantity of a fragrance that was recommended, a new entry in the training database 216 can be added ranking that particular fragrance highly, and ranking the other fragrances lower based on the implication of the user's preference for the fragrance among the set that was actually ordered.

In some cases, a survey can be transmitted to the user after a purchase decision has been made requesting the user to review the specific fragrances that were sent to the user. In these examples, user feedback can be provided directly back to the training database 216

In this manner, the training database 216 continues to grow over time. The training database 216 and datasets within it can be used to periodically retrain the fragranced product preference prediction model 208 and/or the auxiliary prediction model 210. In some cases, multiple different models can be trained from the same underlying data, and performance between the models (e.g., how many recommendations output by the model are purchased and/or repurchased) can be compared. In some cases, the fragranced product preference prediction model 208 can include many versions of the same model, trained on different data or different windows of data from the training database 216. In some cases purchase data or affirmative customer review data may expire and may be removed from the training database 216 at an appropriate time. In other cases, the fragranced product preference prediction model 208 can include multiple different models trained on the same data, output from each of which can be combined and/or compared to generate a set of recommended fragranced products.

In yet other examples, the fragranced product preference prediction model 208 can be configured to provide different contextual recommendations based on the time of year, the geography of a particular user, or other conditions. For example, a user may resonate strongly with recommendations that are earthy and mossy in autumn, whereas the same user may resonate with recommendations that are spiced and woody in the winter, whereas the same user may resonate strongly with recommendations that are herbal and floral in spring. In some cases, users may prefer to lead or lag seasonal changes—a user may enjoy floral scents before spring, or after spring but may feel overwhelmed by floral scents in spring itself.

In yet other examples, recommendations can be informed by a user's geography. For example, a recommendation—or more generally an operation or output of the fragranced product preference prediction model 208—can be for higher concentrations of particular ingredients given high environmental humidity and lower concentrations given low environmental humidity. In other cases, the opposite recommendation may be required.

In other cases, it may be reasonably anticipated that a user spends more time indoors during wintertime; the fragranced product preference prediction model 208 can be configured to recommend lower concentrations of fragrance in such circumstances. In other examples, such as during summer or spring, a user may be predicted to be outdoors frequently and higher concentrations may be appropriate.

In yet other examples, the fragranced product preference prediction model 208 can be configured to consider a user's allergies, or the known allergies or aversions of family or coworkers likely to be in proximity of the user for extended periods of time.

It may be appreciated that the foregoing description of FIG. 2, and the various alternatives thereof and variations thereto, are presented generally, for purposes of explanation, and to facilitate a thorough understanding of various possible configurations of a recommendation engine, such as described herein.

However, it will be apparent to one skilled in the art that some of the specific details presented herein may not be required in order to practice a particular described embodiment, or an equivalent thereof. For example, it may be appreciated that the host service 202 depicted in FIG. 2 can be configured to transact information with a client device, such as the client device 104, to provide recommendations to a user operating the client device in a number of suitable ways.

As discussed above, in some embodiments, the recommendation service 200 is configured to provide user-specific recommendations related to any fragranced product, including perfumes, hair products, body products, skincare products, and so on. The system can be configured to receive user data, such as user demographic, aromatic preferences, and aromatic aversions to generate a recommendations for a suite of fragranced products. In some examples, the fragranced products may have a similar fragrance preference and aversion profile across a spectrum of products. In other examples, the fragranced product may vary depending on the product type. For example, a facial skincare product may have milder fragrances compared to a perfume. In some examples, each fragranced product is complementary of other fragrance such that the fragranced products do not interfere with other recommended products.

While the above examples refer to recommending fragranced products, the recommendation service 200 may generate a fragrance preference and aversion profile for each user. For example, upon receiving user data (e.g., demographics, aroma aversions and/or preferences), the service may provide as output a structured data object that may be stored by a computing system and/or accessed by remote computing systems and parsed thereby, the structured data object defining a fragrance preference and aversion profile (e.g., a combination of scents that a user is likely to be satisfied with). The fragrance preference and aversion profile may be shared (e.g., by the recommendation service with user consent or by the user) with third parties. In some cases, a fragrance preference and aversion profile may be anonymous and identified by a UUID or similar cryptographically secure token. In other cases, the fragrance preference and aversion profile may be directly associated with a user or user credential.

In some examples, a user of hair products may authorize a third party brand to access that user's fragrance preference and aversion profile from the host server 202, or another host associated with a system as described herein. Upon receiving the fragrance preference and aversion profile (or a structured data representation of the same), the third party brand may purchase the user's fragrance preference and aversion profile and/or fragrance preference and aversion profile blend to supply the user with hair products having the user's recommended fragrance preference and aversion profile incorporated into the product.

As another example, the recommendation service 200 can be configured to provide user-specific recommendations for use in commercial settings. In some embodiments, the recommendation service 200 receives user data (e.g., demographics, aromatic aversions and/or preferences) and the recommendation service generates fragrance recommendations as a fragrance preference and aversion profile.

Commercial establishments, such as spas, hotels, salons, and so on, may receive the fragrance preference and aversion profile associated with a user (e.g., via a user authorization for the spa to access the user's fragrance preference and aversion profile), or a group of users such as a family, a couple, or a group otherwise together.

Based on the users' fragrance preference and aversion profile(s) (combined or associated in any suitable manner), the commercial establishment may adjust room fragrances or settings in accordance with the user's fragrance preference and aversion profile. For example, a spa may arrange a diffuser including a fragrance blend matching a user's profile and/or supplied by a system as described herein.

As another example, a hotel may perform turndown service or prepare a room by misting linens with the user's fragrance preference and aversion profile. As yet another example, a leasing office may apply a user's recommended fragrance(s) during a meeting to improve likelihood of a positive experience.

In some embodiments, the recommendation service 200 provides as output structured data (e.g., JSON or XML format as non limiting examples) a set of fragrance recommendations. The fragrance recommendations may correspond to different designed fragrance products. Each fragranced product recommendations may form a portion of, or may otherwise be referenced by, a user's fragrance profile.

A user may choose to authorize access to the user's fragranced profile to any suitable third party. The third party may purchase a suite of fragranced products (e.g., from the entity which provides the recommendation service 200). When a user purchases goods (e.g., to be shipped to the user's home), the third party may infuse the shipped goods with the user's recommended fragrance. For example, a user may purchase clothing online and, while packaging the ordered products, a suitable fragrance may be applied.

In some embodiments, the recommendation service 200 can be configured to provide user-specific recommendation related to household products. As an example, the recommendation service may generate a fragrance recommendation, based on the received user data, related to household products. A fulfillment service may provide infused and/or concentrated fragranced products to add to the household products, such as cleaners, laundry items, and so on. Thus, a user may elect to purchase a household product from any brand (e.g., without fragrance) and add the recommended fragrance. Third party brands may give users options to add the recommended fragrance and provide the user with a fragranced products that matches the user's fragrance preference and aversion profile.

More broadly, the recommendation service 200 may generate recommendations and may communicate with a fulfillment service to provide users fragranced products based on user data. The recommendation service 200 may also generate recommendations 200 for fragranced products which are offered to third parties (e.g., having user authorization) to provide user with goods and services with fragranced goods, services, and/or experiences. As a result of this configuration, users may be less likely to wastefully discard unused scented/fragranced products.

Similarly, the recommendation service may be configured to update a recommended fragrance based on shifting preferences of the user or based on a predetermined period to prevent olfactory fatigue of a fragrance by the user. For example, the recommendation service 200 may regularly update, modify or change a user's fragrance profile to avoid user exhaustion with a particular fragranced product or set of fragranced products.

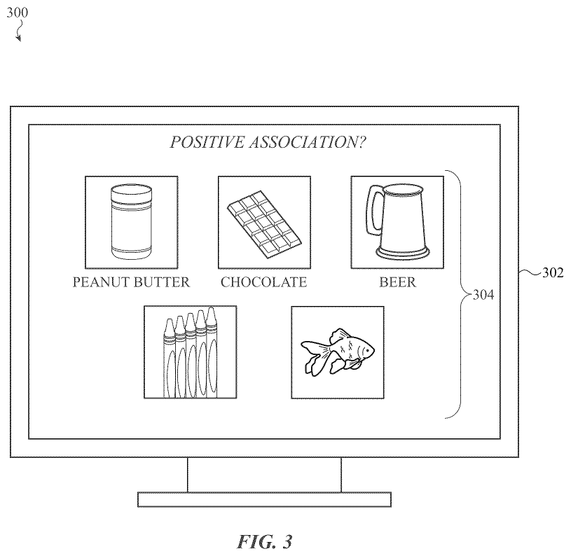

FIG. 3 is an example graphical user interface, identified as the graphical user interface 300, configured to solicit input from a user. The graphical user interface 300 can be rendered on a display of a portable or stationary electronic device.

The electronic device 302 can include a housing supporting and enclosing the display. The electronic device can likewise include a processor and memory, such as described in reference to FIG. 1 The processor and memory can cooperate to instantiate an application, such as a browser application or native application, configured to communicably couple over a computing network to a backend application instance, such as may be associated with a recommendation system such as described herein. In the illustrated embodiment, the graphical user interface 300 is rendered on a display of a desktop computer, but it may be appreciated that this is merely one example construction. Additionally, in this example, the graphical user interface 300 is depicted as rendered by a browser application executing over an operating system, although it is likewise appreciated that this is merely one example. Many constructions are possible to solicit user responses to a survey and to provide a user with recommendations, such as described herein.

Regardless of architecture, user input received at the example graphical user interface 300 can be communicated over a suitable protocol and network connection to a backend application instance executing over appropriate hardware, such as the host server(s) described in reference to foregoing described embodiments. In this example, as input is received from a user it may be communicated in real time, or in response to a user interaction with an affordance advancing to a subsequent page (e.g., submit, next, save, or the like). Once user input is received, and communicated to a host server (e.g., host server 202), the host server can be configured to provide, as a response, a recommendation to the user.

While the above examples describe fragrance products, other goods or services are possible in view of the embodiments described herein. For example, a machine learning model may be trained using longitudinal data from a sample group who have repeatedly completed the same survey and ranked different goods, attributes of those goods, ingredients, and so on.

As described above, in some embodiments, a user survey is the same or substantially the same survey taken by prior users to ensure consistency of data and accurate predictions of a favorable reaction to particular fragranced products.

As noted above, a user survey can include and/or may solicit information so as to suitable derive or infer demographic data, aromatic preferences, and aromatic aversions. The user may input information which may include contact information (e.g., email), identifying information (e.g., name, gender), and other user demographic information. The survey may also include information related to the user's childhood, such as whether the user grew up in an urban or rural environment, whether the user grew up in a certain country, and so on. The survey may also ask about the user's personality, such as whether the user is introverted, the user's preferred vacation spot, and so on.

In some embodiments, the survey is separated by categories. Each category is configured to guide a user through the answers of the survey. For example, the category of demographics may prompt the user to enter factual information while a preferences section may be configured with a faster response interface. In some examples, the survey asks about the user's fragrance preferences, such as how often the user wear fragrances, at what time of day the user prefers to wear fragrances, how strong of a fragrance with user prefers, and so on.

One category may include aromatic preferences and aversions. In some embodiments, the survey prompts the user to rank certain notes in a spectrum between strong dislike and strong preference.

For example, the survey may include questions about preference of floral notes, spicy notes, woody notes, citrus notes, sweet notes, fruity notes, herbal notes, aquatic notes, green notes, earthy notes, and so on. In each question, the survey may include examples and/or imagery to provide a baseline for users. By providing a ranking interface, aromatic preferences and aversions can be identified for each user.

Another category may include everyday items that most users may associate with a distinct smell. For example, certain questions may ask the user to select from a range of options 304 of items that the user likes.

The range of options can include edible and non-edible items, such as peanut butter, menthol, chocolate, wintergreen oil, gasoline, diesel, tuna, baby powder, smoke, mothballs, beer, fruity gum, fruits, bar soap, cinnamon, cardamom, crayons, popcorn, playdough, and so on. A user may elect to choose some, all, or none of the answer choices provided. In some cases, a missing selection may be attributed a negative aromatic preference. In some embodiments, non-elected items may be attributed a neutral aromatic preferences. Each of the survey answers may be transmitted as a set of properties to the host server to provide the recommendation.

In some cases, each question, while apparently unrelated to fragrance preference, may be linked to associative mechanisms that draw users toward or away from certain fragrances. In particular, olfactory senses leverage the amygdala and the hippocampus, which also process emotional and associative learning. In this manner, childhood memories, flavor compounds, and other familiar smells may trigger a strong association in a user with particular fragrances, whether the user is aware of these associations or not.

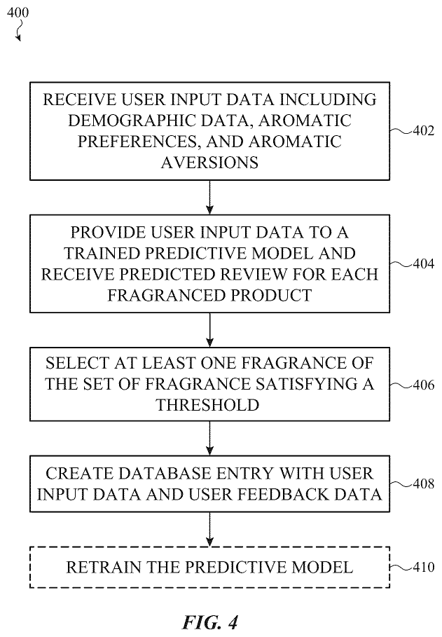

FIG. 4 illustrates an example method 400 for providing a fragranced product recommendation. The method 400 can include additional operations not depicted or can exclude operations depicted. Generally, the method 400 receives user input from a survey and selects fragranced products using a machine learning algorithm.

At operation 402, user input data is received. As described herein, the user data includes demographic data, aromatic preferences, and aromatic aversions. This list is non-exhaustive. The user data may be received as a table, matrix, or any other data structure as may be known to one of skill in the art. The user data corresponds to user survey entries provided by the user.

At operation 404, the received user input data is provided to a trained machine learning model. Upon ingesting the input data, the trained machine learning model outputs a set of values corresponding to a predicted review of a fragranced product by the user or to a predicted likelihood that the user will be satisfied with the fragranced product.

These values may be output for each fragranced product of the suite of fragranced products in the entity's brand. This suite of fragranced products corresponds to at least a majority of the fragranced products upon which the machine learning model was trained. For example, if the sample user group sampled a citrus fragrance, a woody fragrance, and a spicy fragrance (as a simplified example), the output of the machine learning model is a predicted review value corresponding to each the citrus, woody, and spicy fragrances.

At operation 406, a fragranced product is selected. In some examples, a group of fragranced product is selected. The selection criteria can be based on a high predicted review value, a neutral review value, a ranking of values, and so on. The fragranced product is selected when a threshold criteria (such as a criteria associated with a positive review) is satisfied. In some embodiments, multiple fragranced products may satisfy the criteria and a subset of fragranced products may be selected based on ranking or at random.

In some embodiments, the methods selects a group of fragranced products including a random fragranced product which may not satisfy a criteria or threshold described herein. The additional random fragrance may be selected to provide the user with an additional option in case the prediction does not match the user's expectation. The random fragrance may also be selected as a way to verify that the machine learning algorithm is predicting user satisfaction with a high confidence level.

At operation 408, a new database entry is created. The new database entry includes the demographic data of the user, the aromatic preferences and aversions of the user, and other entries obtained from the user survey. The database entry may also include the values output from the predictive model for each fragranced product and the selected fragranced products (and corresponding values). In some cases, user feedback is solicited after the user has sampled the selected fragrances. User feedback may be received as a single score for the sample kit, for each of the fragranced products, as a ranking of preferred fragranced products, or in any other manner. The user feedback may be input with the database entry linked to the user's profile.

At operation 410, the predictive model may be retrained. The predictive model is retrained using database entries from users which have conducted the survey and received at least one fragrance, for example. The retraining may take place periodically. Alternatively, the retraining may take place once a statistically significant number of database entries are obtained. In some examples, the method may filter outlier database entries from the training data. By retraining the model, the recommendations may be more accurate and may capture a wider demographic than the initial sample group. Similarly, as new fragranced products are added, the predictive model may be retrained to account for the new fragranced products.

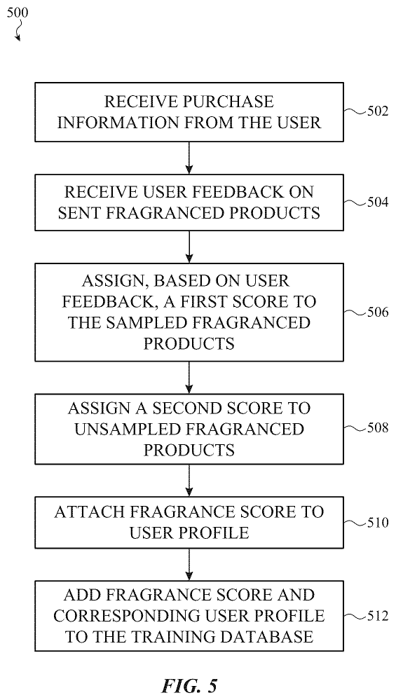

FIG. 5 depicts an example method 500 for creating a database entry. This method structures database entries for retraining the model which, in turn, improves the accuracy of the prediction. At operation 502, purchase information from a user is received. The purchase information is associated with the user purchasing at least one recommended fragrance and/or a sample kit having recommended fragrances. The purchase information may be linked to the received user input data (e.g., from the user survey) and the values for each fragranced product output from the predictive model. Receiving the purchase information may indicate that a user has provided accurate information and decided to purchase at least one product.

At operation 504, user feedback for the fragranced products is received. As described herein, the user may rank the fragranced products received, may score the sample kit received as a whole, may provide a score for each of the fragranced products, and so on. In some cases, user feedback may be solicited following a trial period which enables the user to wear the fragrances for an extended period, combine the fragrances, and sample multiple fragrances. Unlike physical stores or other sampling methods, enabling ample time for the user to wear the fragranced products prevents the olfactory fatigue generally associated with sampling more than one fragrance in a short time period.

Similarly, by sampling the fragranced product for an extended period (e.g., one day, two days, and so on), the user may detect changes in the fragrance preference and aversion profile (e.g., the user may detect more base notes as the fragranced product wears). Thus, the user may determine that both the initial and lasting notes of the fragrance are satisfactory. The user may also determine that the initial note of the fragrance was satisfactory but the base notes of the fragrance did not completement the user. In either situation, the user can make a more informed choice and avoid waste generally associated with a user disliking the fragrance after sampling it.

At operation 506, based on the user feedback, a first score is assigned to the at least one sample fragrance. For example, if the user sampled four fragrances and provided a “thumbs up” review for the kit, a first score associated with user satisfaction (e.g., 7 out of 10, 100 out of 100, and so on) may be assigned to each of the four fragrances sent. In some embodiments, the values assigned to the sent fragranced products may be equal to the values output by the predictive model if the user provides a positive review to the sample fragranced products. In some embodiments, the user may assign a score to each of the fragranced products received. The values assigned may be equal to the scores provided by the user, for example.

At operation 508, a second score is assigned to the unsampled fragranced products. The second score may be associated with a score below a threshold (e.g., not satisfying a selection criteria for a recommended fragrance). By assigning the second score to the unsampled fragrances, the database entry has values for all fragranced products, which may subsequently be used to retrain the predictive model. In some embodiments, the second score is a score associated with a negative review (e.g., associated with the user disliking the fragrance product).

At operation 510, the values for the fragranced products (e.g., the first score of the sampled fragrances and the second score for the unsampled fragrances) are attached or linked to the user profile. As described herein, the user profile refers to the user input data received from the user survey. The user profile may be associated with an address or other information that removes user identifying data (e.g., name of the user) for privacy purposes and to prevent bias in the training data.

At operation 512, the values or scores of the fragranced products and associated user profile are added to a training database. The training database is used by the predictive model service (e.g., predictive model service 204 from FIG. 2) to retrain the predictive model.

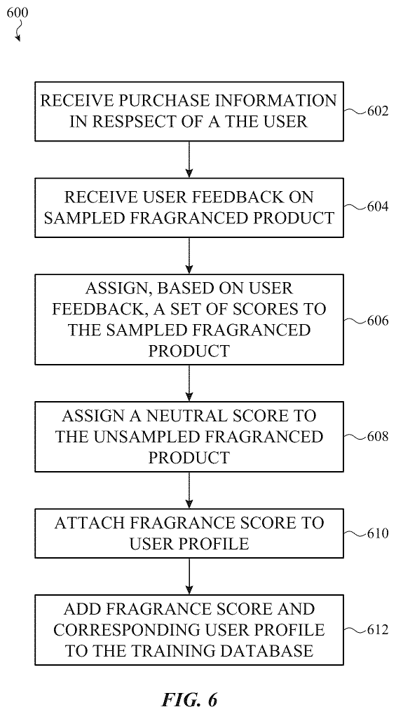

FIG. 6 depicts an example method 600 for creating a database entry. At operation 602, purchase information from a user associated with the user purchasing at least one recommended fragrance and/or a sample kit of recommended fragrances is received.

At operation 604, user feedback for the fragranced product is received (e.g., by the host server. The use feedback may include a score for the fragranced product received. The system may assign a score to each of the samples received based on the user's feedback. The assigned scores are associated with a positive, neutral, or negative sentiments from the user of the received fragrances.

Similarly, at operation 606, the system assigns a neutral score to the unsampled fragrances. Unlike operation 506 above, a neutral score is less likely to bias the predictive results against unsampled fragrances. At operation 608, each the score of the sampled fragrances and the neutral score of the unsampled fragrances are attached or linked to the user's profile (e.g., user survey and other linking information). At operation 610, the linked user profile and associated scores are added to the training database which may be used to retrain the predictive model.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

As used herein, the term “computing resource” (along with other similar terms and phrases, including, but not limited to, “computing device” and “computing network”) refers to any physical electronic devices or machine component, or set or group of interconnected and/or communicably coupled physical and/or virtual electronic devices or machine components, suitable to execute or cause to be executed one or more arithmetic or logical operations on digital data.

Example computing resources contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

The foregoing examples and description of various instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel.

In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference an implementation in which discrete functions of the system are implemented as discrete microservices. It is appreciated that this is merely one possible implementation.

It may be further appreciated that a request-response RESTful system implemented in whole or in part over cloud infrastructure is merely one example architecture of a system as described herein. More broadly, a system as described herein can include a frontend and a backend configured to communicably couple and to cooperate in order to execute one or more operations or functions as described herein. In particular, a frontend may be an instance of software executing by cooperation of a processor and memory of a client device. Similarly, a backend may be an instance of software and/or a collection of instantiated software services (e.g., microservices) each executing by cooperation of a processor resource and memory resources allocated to each respective software service or software instance.

Backend software instances can be configured to expose one or more endpoints that frontend software instances can be configured to leverage to exchange structured data with the backend instances. The backend instances can be instantiated over first-party or third-party infrastructure which can include one or more physical processors and physical memory devices. The physical resources can cooperate to abstract one or more virtual processing and/or memory resources that in turn can be used to instantiate the backend instances.

The backend and the frontend software instances can communicate over any suitable communication protocol or set of protocols to exchange structured data. The frontend can, in some cases, include a graphical user interface rendered on a display of a client device, such as a laptop computer, desktop computer, or personal phone. In some cases, the frontend may be a browser application and the graphical user interface may be rendered by a browser engine thereof in response to receiving HTML served from the backend instance or a microservice thereof.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

As described herein, the term “memory” refers to any software and/or hardware-implemented data storage device or circuit physically and/or structurally configured to store data in a non-transitory or otherwise nonvolatile, durable manner. This term is meant to encompass memory devices, memory device arrays (e.g., redundant arrays and/or distributed storage systems), electronic memory, magnetic memory, optical memory, and so on.

One may appreciate that although many embodiments are disclosed above, that the operations and operations presented with respect to methods and techniques described herein are meant as exemplary and accordingly are not exhaustive. One may further appreciate that alternate operation order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

What is claimed is:

1. A server system for supplementing training data, the server system configured to instantiate a backend application instance configured to communicably couple to a frontend application instance instantiated by an end-user computing device, the server system comprising:
a database service storing training data, the training data defined in part by entries in a table, each entry comprising:
a set of properties comprising:
demographic data of a prior user of the server system;
aromatic note preferences of the prior user; and
aromatic note aversions of the prior user; and
a set of values each corresponding to a respective one fragranced product, each respective value defined by one of:
a purchase by the prior user of the respective one fragranced product; or
a review by the prior user of the respective one fragranced product;
a memory resource storing instructions for instantiating the backend application instance;
a processing resource configured to cooperate with the memory resource to execute the instructions to instantiate the backend application instance, the backend application instance configured to:
instantiate a trained machine learning model, the trained machine learning model trained from the training data stored by the database service and configured to assign a value to each of a set of fragranced products in response to receiving input data provided by a user of the frontend application instance;
receive first input data from the frontend application instance, the first input data comprising:
demographic data of the user;
aromatic note preferences of the user; and
aromatic note aversions of the user;
provide the received input data to the trained machine learning model as input;
receive from the trained machine learning model, a set of values each value corresponding to a predicted review of one respective fragranced product by the user;
select a group of fragranced products corresponding to a subset of the set of values satisfying a threshold; and
transmit fragranced product selection data configured to elicit the user to sample.

2. The server system of claim 1, wherein the backend application instance is configured to:
select another fragranced product at random to add to the group; and
transmit sampling kit data comprising the selected group of fragranced products and the random fragranced product, the sampling kit configured to elicit the user to sample at least one selected fragranced product.

3. The server system of claim 1, wherein the backend application instance is configured to
receive purchase information indicating the user completed a purchase for the group of fragranced products selected by the machine learning model.

4. The server system of claim 3, wherein the backend application instance is configured to:
create, with the database service, a new entry in the training data comprising:
the demographic data of the user;
the aromatic note preferences of the user;
the aromatic note aversions of the user; and
a value satisfying the threshold in respect of the purchased fragranced product.

5. The server system of claim 4, wherein the new entry in the training data comprises:
a neutral value corresponding to a set of remaining fragranced products different from the group of fragranced products selected by the machine learning model, the neutral value corresponding to a neutral review score.

6. The server system of claim 4, wherein the new entry in the training data comprises:
a negative-sentiment value corresponding to a set of remaining fragranced products different from the group of fragranced products selected by the machine learning model, the negative-sentiment value corresponding to a negative review score.

7. The server system of claim 4, wherein the backend application instance is configured to retrain the trained machine learning model from the updated training data.
